(19) United States
(12) Patent Application Publication
(10) Pub. No.: US 2014/0181760 A1
(43) Pub. Date: Jun. 26, 2014

(54) ELECTRONIC DEVICE AND METHOD FOR UNLOCKING TOUCH SCREEN THEREOF

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventor: HUNG-CHI HUANG, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/140,548

(22) Filed: Dec. 26, 2013

(30) Foreign Application Priority Data
Dec. 26, 2012 (TW) 101150251

(51) Int. Cl. G06F 3/0488

(52) U.S. Cl. CPC G06F 3/0488
USPC 715/863

(57) ABSTRACT

A method for unlocking a touch screen of an electronic device includes the following steps. First, touch signals are generated in response to manual touch operations on the touch screen. Second, a shape is identified according to the touch signals. Third, the touch screen is unlocked if the identified shape is substantially the same as a predefined shape, wherein the predefined shape is a shape of two fingertips simultaneously sliding in a direction from up to down on the touch screen. An electronic device equipped for unlocking a touch screen thereof is also provided.

### BACKGROUND

1. Technical Field

The present disclosure relates to electronic devices and proper and authorized use thereof, and especially to an electronic device with a touch screen and a method for unlocking the touch screen of the electronic device.

2. Description of Related Art

Electronic devices with touch screens are very popular nowadays. Such electronic devices include mobile phones, tablet personal computers, digital cameras, digital photo frames, and electronic readers (e-readers), for example. To avoid a user operating the touch screen unintentionally, the touch screen is locked when not in use. An unlocking procedure such as a sliding touch on the touch screen is needed for unlocking the touch screen. However, the unlocking procedure is mundane. Also, a typical unlocking procedure does not prevent an unauthorized user from gaining access to the electronic device.

Therefore, what is needed is an electronic device and a method for unlocking a touch screen thereof which can alleviate or overcome the limitations described above.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts or sections throughout the views.

FIG. 1 is a block diagram of an electronic device in accordance with an embodiment of the present invention.

FIG. 2 is a top plan view of the electronic device of FIG. 1, showing a slide shape applied on a touch screen of the electronic device.

FIGS. 3A and 3B together constitute a single flowchart of a method for unlocking a touch screen of an electronic device, such as the one of FIG. 1, in accordance with an embodiment of the present invention.

### DETAILED DESCRIPTION

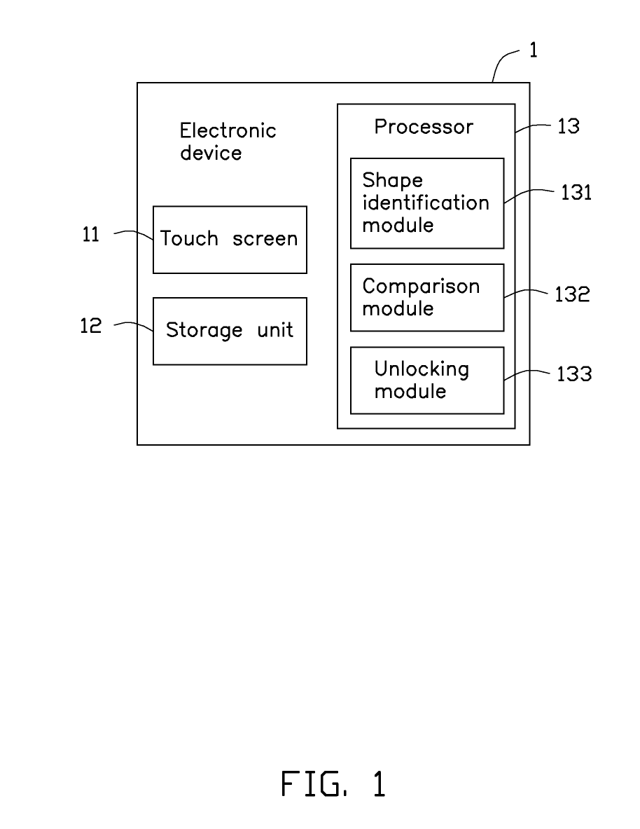

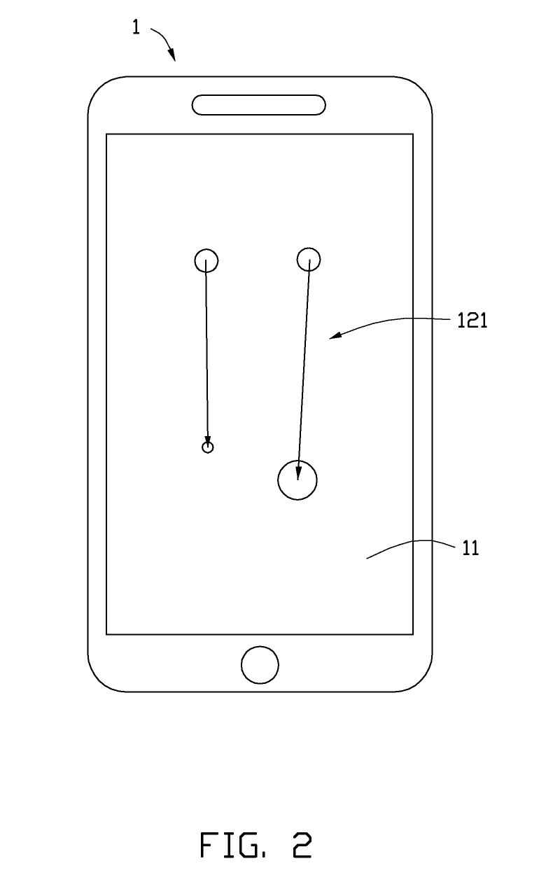

FIGS. 1 and 2 show an electronic device 1 in accordance with an embodiment. The electronic device 1 is typically a terminal device such as a personal computer or a tablet computer, for example. The electronic device 1 has a touch screen 11.

The electronic device 1 mainly includes the touch screen 11, a storage unit 12, and a processor 13.

The touch screen 11 is configured for generating input signals in response to sliding touch operations applied thereon.

The storage unit 12 stores a predefined shape 121. FIG. 2 shows a shape applied on the touch screen 11. The shape is traced by a user, and is intended to mimic (or duplicate) the predefined shape 121. In FIG. 2, for the purposes of illustration, the shape applied is exactly the same as the predefined shape 121. In this example, the predefined shape 121 is a slide shape of two fingertips simultaneously sliding in a direction from up to down on the touch screen 11. The slide shape thus comprises two sliding tracks. Each sliding track includes an origin point and an end point. In this description, unless the context indicates otherwise, a reference to a “shape” can include a reference to a trace(s), pattern or other form that can be applied on the touch screen 11 by a user.

For each sliding track, the pressure of the origin point applied on the touch screen is different from the pressure of the end point applied on the touch screen. If the pressure applied on the origin point is greater than the pressure applied on the end point, the pressure relationship between the origin point and the end point is that the pressure applied on origin point is greater than the pressure applied on the end point. If the pressure applied on the origin point is less than the pressure applied on the end point, the pressure relationship between the origin point and the end point is that the pressure applied on origin point is less than the pressure applied on the end point. In FIG. 2, for the left-side sliding track, the pressure applied on the origin point is greater than the pressure applied on the end point; and for the right-side sliding track, the pressure applied on the origin point is less than the pressure applied on the end point.

The processor 13 includes a shape identification module 131, a comparison module 132, and an unlocking module 133.

The shape identification module 131 is configured for identifying a shape in response to the input signals generated by the touch screen 11.

The comparison module 132 is configured for comparing the identified shape with the predefined shape 121 stored in the storage unit 12, and for determining whether the identified shape is substantially the same as the predefined shape 121 stored in the storage unit 12. The comparison module 132 is further configured for generating a signal for unlocking the touch screen 11 when the identified shape is substantially the same as the predefined shape 121.

In detail, the comparison module 132 is configured for determining whether the identified shape is a shape of two fingertips simultaneously sliding in a direction from up to down on the touch screen 11. If so, the comparison module 132 is further configured for determining whether the distance between the two origin points of the identified shape is substantially equal to the distance between the two origin points of the predefined shape 121. If so, the comparison module 132 is further configured for determining whether the sliding tracks of the identified shape are substantially identical to the sliding tracks of the predefined shape 121. If so, the comparison module 132 is further configured for determining whether the pressure relationships between the origin points and the end points of the identified shape are the same as the corresponding pressure relationships between the origin points and the end points of the predefined shape 121. If so, the comparison module 132 is further configured for generating a signal for unlocking the touch screen 11.

The unlocking module 133 is configured for unlocking the touch screen 11 in response to the generated signal.

In the embodiment, the distance between the two origin points of the identified shape being substantially equal to the distance between the two origin points of the predefined shape 121 relates to the distance between the two origin points of the identified shape being approximately equal to the distance between the two origin points of the predefined shape 121, with a predefined margin of error.

In the embodiment, the sliding tracks of the identified shape being substantially identical to the sliding tracks of the predefined shape 121 relates to a degree of similarity between the sliding tracks of the identified shape and the sliding tracks of the predefined shape 121 being greater than a predetermined value.

In the embodiment, the pressure relationships between the origin points and the end points of the identified shape being the same as the corresponding pressure relationships between the origin points and the end points of the predefined shape 121 relates to the pressure relationship between the origin point and the end point of each identified sliding track being the same as the pressure relationship between the origin point and the end point of the corresponding sliding track of the predefined shape 121.

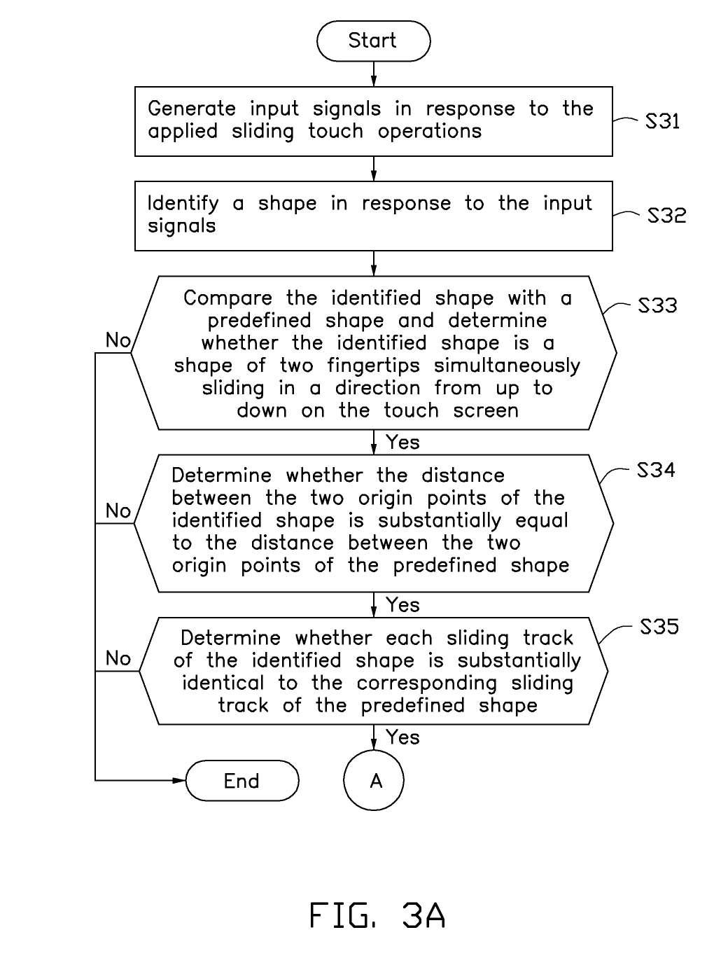

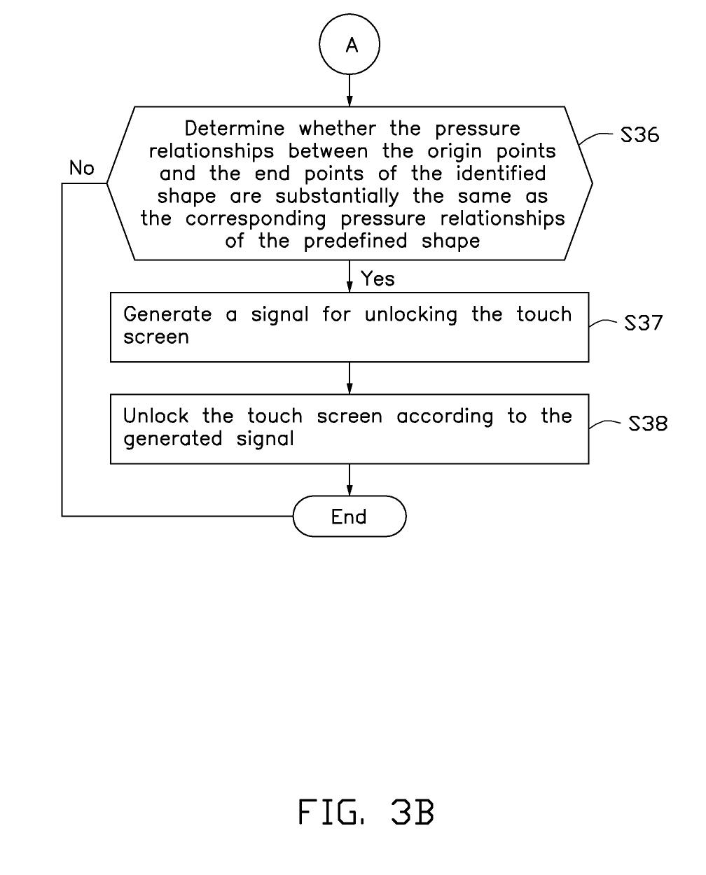

FIGS. 3A and 3B together constitute a single flowchart of a method for unlocking a touch screen of an electronic device, such as the electronic device 1, in accordance with an embodiment. The electronic device 1 includes a touch screen 11 and a storage unit 12. The touch screen 11 is configured for generating input signals in response to sliding touch operations applied thereon. The storage unit 12 stores a predefined shape 121. The method typically includes the following steps, each of which is related to the various components contained in the electronic device 1.

In step S31, the touch screen 11 generates input signals in response to applied sliding touch operations.

In step S32, the shape identification module 131 identifies a shape according to the input signals generated by the touch screen 11.

In step S33, the comparison module 132 compares the identified shape with a predefined shape and determines whether the identified shape is a shape of two fingertips simultaneously sliding in a direction from up to down on the touch screen 11. If the determination is yes, the process goes to step S34. Otherwise, the process ends.

In step S34, the comparison module 132 determines whether the distance between the two origin points of the identified shape is substantially equal to the distance between the two origin points of the predefined shape 121. If the determination is yes, the process goes to step S35. Otherwise, the process ends.

In step S35, the comparison module 132 determines whether each sliding track of the identified shape is substantially identical to the corresponding sliding track of the predefined shape 121. If the determination is yes, the process goes to step S36. Otherwise, the process ends.

In step S36, the comparison module 132 determines whether the pressure relationship between the origin point and the end point of each sliding track of the identified shape is the same as the pressure relationship between the origin point and the end point of the corresponding sliding track of the predefined shape 121. If the determination is yes, the process goes to step S37. Otherwise, the process ends.

In step S37, the comparison module 132 generates a signal for unlocking the touch screen 11.

In step S38, the unlocking module 133 unlocks the touch screen 11 in response to the generated signal.

Although the present disclosure has been specifically described on the basis of various embodiments, the disclosure is not to be construed as being limited thereto. Various changes or modifications may be made to the embodiments without departing from the scope and spirit of the disclosure.

What is claimed is:

1. A method for unlocking a touch screen of an electronic device having a storage unit, the storage unit having a predefined shape stored therein, the predefined shape being a shape of two fingertips simultaneously sliding in a direction from up to down on the touch screen, the method comprising:
generating input signals in response to slide operations applied on the touch screen;
identifying a shape according to the input signals;
comparing the identified shape with the predefined shape and determining whether the identified shape is substantially the same as the predefined shape; and
unlocking the touch screen when the identified shape is substantially the same as the predefined shape.

2. The method as described in claim 1, wherein determining whether the identified shape is substantially the same as the predefined shape comprises:
determining whether the identified shape is a shape of two fingertips simultaneously sliding in a direction from up to down on the touch screen;
determining whether a distance between two origin points of the identified shape is substantially equal to a distance between two origin points of the predefined shape;
determining whether each sliding track of the identified shape is substantially identical to a corresponding sliding track of the predefined shape; and
determining whether a pressure relationship between the origin point and an end point of each sliding track of the identified shape is the same as a pressure relationship between the origin point and an end point of the corresponding sliding track of the predefined shape.

3. The method as described in claim 2, wherein the pressure relationship between the origin point and the end point of each sliding track is one of the pressure applied on the origin point by a user being greater than the pressure applied on the end point by the user, and the pressure applied on the origin point by a user being less than the pressure applied on the end point by the user.

4. An electronic device, comprising:
a storage unit having a predefined shape stored therein, the predefined shape being a shape of two fingertips simultaneously sliding in a direction from up to down on the touch screen;
a touch screen, configured for generating input signals in response to slide operations applied thereon;
a shape identification module, configured for identifying a shape according to the input signals;
a comparison module, configured for comparing the identified shape with the predefined shape stored in the storage unit, and for determining whether the identified shape is substantially the same as the predefined shape; and
an unlocking module, configured for unlocking the touch screen when the identified shape is substantially the same as the predefined shape.

5. The electronic device as described in claim 4, wherein the comparison module is configured for determining that the identified shape is substantially the same as the predefined shape upon determining that:
the identified shape is a shape of two fingertips simultaneously sliding in a direction from up to down on the touch screen;
a distance between two origin points of the identified shape is substantially equal to a distance between two origin points of the predefined shape;
each sliding track of the identified shape is substantially identical to a corresponding sliding track of the predefined shape; and
a pressure relationship between the origin point and an end point of each sliding track of the identified shape is the same as a pressure relationship between the origin point and an end point of the corresponding sliding track of the predefined shape.

6. The electronic device as described in claim 5, wherein the pressure relationship between the origin point and the end point of each sliding track is one of the pressure applied on the origin point by a user being greater than the pressure applied on the end point by the user, and the pressure applied on the origin point by a user being less than the pressure applied on the end point by the user.
